(19) United States
(12) Patent Application Publication
(10) Pub. No.: US 2007/0009238 A1
(43) Pub. Date: Jan. 11, 2007

(54) Optical disc apparatus

(75) Inventor: Tomohiro Nakano, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/482,936

(22) Filed: Jul. 10, 2006

(30) Foreign Application Priority Data
Jul. 11, 2005 (JP) 2005-201727

(51) Int. Cl. H04N 5/00

(52) U.S. Cl. 386/126

(57) ABSTRACT

In an optical disc apparatus, set-up items include an item named “feel difference in effect” which includes at least an item concerning a video adjusting function and an item concerning a sound effect generating function, and a system controller is provided that operates such that, when the video adjusting function is selected, a video-adjustment video signal previously stored in a memory is fed to a video output circuit to display video such that an exaggerated difference is effected by the video adjusting function and, when the sound effect generating function is selected, a sound-effect-generation audio signal previously stored in the memory is fed to an audio output circuit to output audio such that an exaggerated difference is effected by the sound effect generating function. With this configuration, with respect to functions whose effects are difficult to guess from a user's manual, specific examples are presented in the course of a set-up operation so that the user can, by actually looking at and listening to their effects, feel the differences produced by those functions when enabled in comparison with when disabled. The user can thereby fully realize in what situations (in video and audio) to use those functions and thus effectively use them.

This application is based on Japanese Patent Application No. 2005-201727 filed on Jul. 11, 2005, the contents of which are hereby incorporated by reference.

### BACKGROUND OF THE INVENTION

1. Field of the Invention

The present invention relates to an optical disc apparatus that permits playback of information recorded on an optical disc, and to an optical disc apparatus that permits recording and playback of information to and from an optical disc. More particularly, the present invention relates to processing for setting up such an optical disc apparatus into a desired state.

2. Description of Related Art

Conventionally, optical disc apparatuses, such as DVD players that permit playback of information recorded on optical discs such as DVDs (digital versatile discs) and DVD recorders that permit recording and playback of information to and from optical discs such as DVDs, can be set up to operate with desired operating conditions. In a set-up operation, the user has a set-up screen displayed, for example, on a television monitor, and makes settings, if he does not know how to set up, while consulting the user's manual. The items on which settings can be made in a set-up operation concern, among others, functions for setting power saving, functions for setting display preferences, functions for setting channel preferences, functions for setting BS preferences, functions for setting date and time, functions for setting times recordings, functions for setting video properties, and functions for setting audio properties.

With regard to the functions these set-up items concern, explanations are indeed given in the user's manual, but no specific examples are presented in the course of a set-up operation. Thus, in conventional optical disc apparatuses, inconveniently, the user has difficulty in making settings concerning some functions. For example, among functions related to video properties, a function for black level switching or noise reduction suppression poses the user difficulty in recognizing a difference it produces when enabled in comparison with when disabled; among functions related to audio properties, a function for virtual surround sound effect generation poses the user difficulty in recognizing a difference it produces when enabled in comparison with when disabled.

Incidentally, according to the conventional technique disclosed in JP-A-2003-248657, a Web page is set up that provides guidance on how to operate a console, and a server is provided that accesses the Web page to recognize set conditions in order to execute control with the set conditions thus recognized. This indeed makes it easier for the user to make settings, but here no consideration is given to making it easier for the user to recognize, with respect to a function that poses the user difficulty in recognizing a difference it produces when enabled in comparison with when disabled, this difference.

According to the conventional technique disclosed in JP-A-H11-53377, guidance on operation is given in a set-up manual in the form of an electronic manual composed of still pictures, moving pictures, sounds, and the like. Here, too, no consideration is given to making it easier for the user to recognize, with respect to a function that poses the user difficulty in recognizing a difference it produces when enabled in comparison with when disabled, this difference.

### SUMMARY OF THE INVENTION

In view of the conventionally experienced inconveniences mentioned above, it is an object of the present invention to provide an optical disc apparatus that lets the user feel the effect of a function whose effect is difficult to guess from its description in a user's manual.

To achieve the above object, according to the present invention, in an optical disc apparatus that permits playback of information recorded on an optical disc or that permits recording and playback of information to and from an optical disc, set-up items include an item named “feel difference in effect” which includes at least an item concerning a video adjusting function and an item concerning a sound effect generating function, and a system controller is provided that operates such that, when the video adjusting function is selected, a video-adjustment video signal previously stored in a memory is fed to a video output circuit to display video such that an exaggerated difference is effected by the video adjusting function and, when the sound effect generating function is selected, a sound-effect-generation audio signal previously stored in the memory is fed to an audio output circuit to output audio such that an exaggerated difference is effected by the sound effect generating function.

With this configuration, when the video adjusting function is selected, the video-adjustment video signal stored in the memory is fed to the video output circuit to display video such that an exaggerated difference is effected by the video adjusting function and, when the sound effect generating function is selected, the sound-effect-generation audio signal previously stored in the memory is fed to the audio output circuit to output audio such that an exaggerated difference is effected by the sound effect generating function.

Thus, with this configuration, with respect to functions whose effects are difficult to guess from a user's manual, specific examples are presented in the course of a set-up operation so that the user can, by actually looking at and listening to their effects, feel the differences produced by those functions when enabled in comparison with when disabled. The user can thereby fully realize in what situations (in video and audio) to use those functions and thus effectively use them.

### BRIEF DESCRIPTION OF THE DRAWINGS

FIG. 1 is a block diagram showing the configuration of a DVD recorder as an example of an optical disc apparatus embodying the present invention;

FIG. 2 is a flow chart of the procedure for including a “feel difference in effect” item among step-up items in designing stages;

FIG. 3 is a diagram showing examples of a set-up screen;

FIG. 4A is a diagram showing an example of video displayed when a black level switching function is off;

FIG. 4B is a diagram showing an example of video displayed when the black level switching function is on;

FIG. 5A is a diagram showing an example of video displayed when a noise reduction suppressing function is off;

FIG. 5B is a diagram showing an example of video displayed when the noise reduction suppressing function is on;

FIG. 6 is a flow chart showing the procedure for letting the user feel the differences effected by functions for which settings can be made in a set-up operation;

FIG. 7 is a continuation of the flow chart shown in FIG. 6 showing the procedure for letting the user feel the differences effected by functions for which settings can be made in a set-up operation; and

FIG. 8 is a continuation of the flow chart shown in FIG. 6 showing the procedure for letting the user feel the differences effected by functions for which settings can be made in a set-up operation.

### DETAILED DESCRIPTION OF PREFERRED EMBODIMENTS

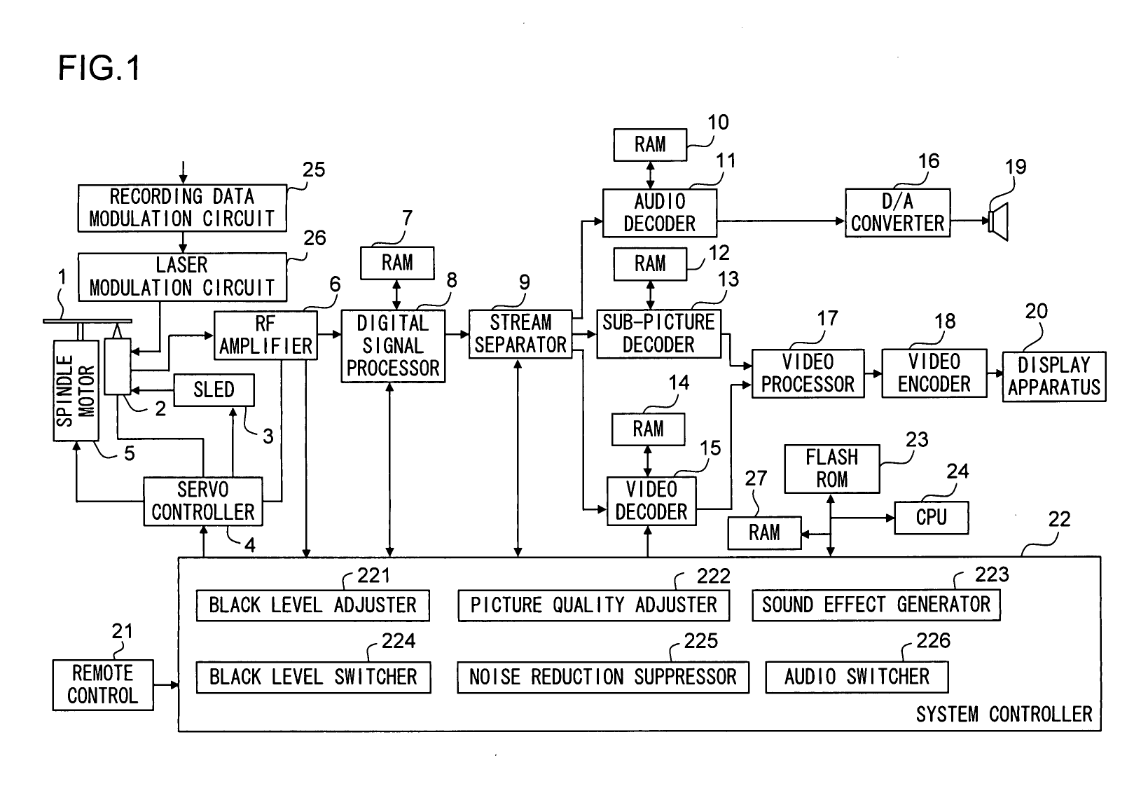

Hereinafter, with reference to the accompanying drawings, an embodiment of the present invention will be described. FIG. 1 is a block diagram showing the configuration of a DVD recorder as an example of an optical disc apparatus embodying the present invention

The DVD recorder is provided with: a spindle motor 5 that rotates an optical disc 1; an optical pickup 2 that emits laser light with which to record and play back information to and from the optical disc 1 and that receives the laser light reflected from the optical disc 1; a sled 3 that moves the optical pickup 2 in a direction radial to the optical disc 1; a system controller 22 that controls the apparatus as a whole; and a servo controller 4 that drives the spindle motor 5 and the sled 3 according to instructions from the system controller 22 and that moves an objective lens (unillustrated) included in the optical pickup 2 so as to move the focus position of the laser light in directions perpendicular and parallel to a recording surface of the optical disc 1.

The DVD recorder is further provided with: an RF amplifier 6 that amplifies an RF signal fed, as a read signal, from the optical pickup 2 during playback from the optical disc 1; a digital signal processor 8 that converts the RF signal outputted from the RF amplifier 6 into digital data, then performs signal decoding and ECC error correction on the resulting data according to the data format of the optical disc 1, and then stores the resulting data in a RAM 7; and a stream separator 9 that separates audio data, sub-picture data, and video data from the data stream outputted from the digital signal processor 8 according to instructions from the system controller 22.

The DVD recorder is further provided with: an audio decoder 11 that receives the audio data outputted from the stream separator 9 and performs predetermined decoding on it; a RAM 10 that temporarily stores data for the decoding performed by the audio decoder 11; a sub-picture decoder 13 that receives the sub-picture data outputted from the stream separator 9 and performs predetermined decoding on it; a RAM 12 that temporarily stores data for the decoding performed by the sub-picture decoder 13; a video decoder 15 that receives the video data outputted from the stream separator 9 and performs predetermined decoding on it; and a RAM 14 that temporarily stores data for the decoding performed by the video decoder 15.

The DVD recorder is further provided with: a video processor 17 that synthesizes the data outputted from the video decoder 15 and the data outputted from the sub-picture decoder 13 according to instructions from the system controller 22; a video encoder 18 that converts the synthesized data outputted from the video processor 17 into a video signal for display to display video on a display apparatus 20; and a D/A converter 16 that converts the data outputted from the audio decoder 11 into an analog audio signal and feeds it via an unillustrated audio amplification circuit to, for example a speaker 19.

The DVD recorder is further provided with: a remote control 21 having various operation keys for sending commands in the form of infrared signals to the system controller 22, the operation keys including a “play” key for giving a command to start playback, a “stop” key for giving a command to stop playback, a “record” key for giving a command to start recording, and a “power” key; a flash ROM 23 that stores programs and data for controlling the individual functional blocks of the apparatus and for controlling the apparatus as a whole; a CPU 24 that performs computational processing according to the programs and data stored in the flash ROM 23 to control the system controller 22; and a RAM 27 that temporarily stores data necessary for the processing performed by the CPU 24.

The DVD recorder is further provided with a recording data modulation circuit 25 that modulates video/audio data fed from an unillustrated television tuner or personal computer to make it ready to be recorded to the optical disc 1; and a laser modulation circuit 26 that feeds the optical pickup 2 with a laser modulation signal for modulating the laser light emitted from the optical pickup 2 according to the modulated data modulated by the recording data modulation circuit 25.

The system controller 22 is provided with, as functional blocks that constitute distinctive features of the embodiment under discussion: a black level adjuster 221 that adjusts, with respect to a video output circuit (specifically, here, the video decoder 15) that outputs a video signal obtained by performing predetermined processing on a playback signal played back from the optical disc 1, the black level of the video signal; a picture quality adjuster 222 that adjusts the sharpness of video to reduce noise reduction in the video; and a sound effect generator 223 that generates, with respect to an audio output circuit (specifically, here, the audio decoder 11) that outputs an audio signal obtained by performing predetermined processing on a playback signal played back from the optical disc 1, a sound effect such as a virtual surround effect.

The system controller 22 is further provided with: a black level switcher 224 that, when a black level switching function is selected, feeds a black-level-adjustment video signal previously stored in the flash ROM 23 to the video output circuit and drives the black level adjuster 221 to switch the black level such that an exaggerated difference is effected by the black level switching function; a noise reduction suppressor 225 that, when a noise reduction suppressing function is selected, feeds a noise-reduction-suppression video signal previously stored in the flash ROM 23 to the video output circuit and drives the picture quality adjuster 222 to adjust picture quality such that an exaggerated difference is effected by the noise reduction suppressing function; and an audio switcher 226 that, when a sound effect generating function is selected, feeds a sound-effect-generation audio signal previously stored in the flash ROM 23 to the audio output circuit and drives the sound effect generator 223 to switch audio such that an exaggerated difference is effected by the sound effect generating function.

Needless to say, although the embodiment under discussion deals with a DVD recorder as an example of an optical disc apparatus, the features described above can be realized equally when the system controller of a playback-only DVD player is provided with functional blocks similar to those described above.

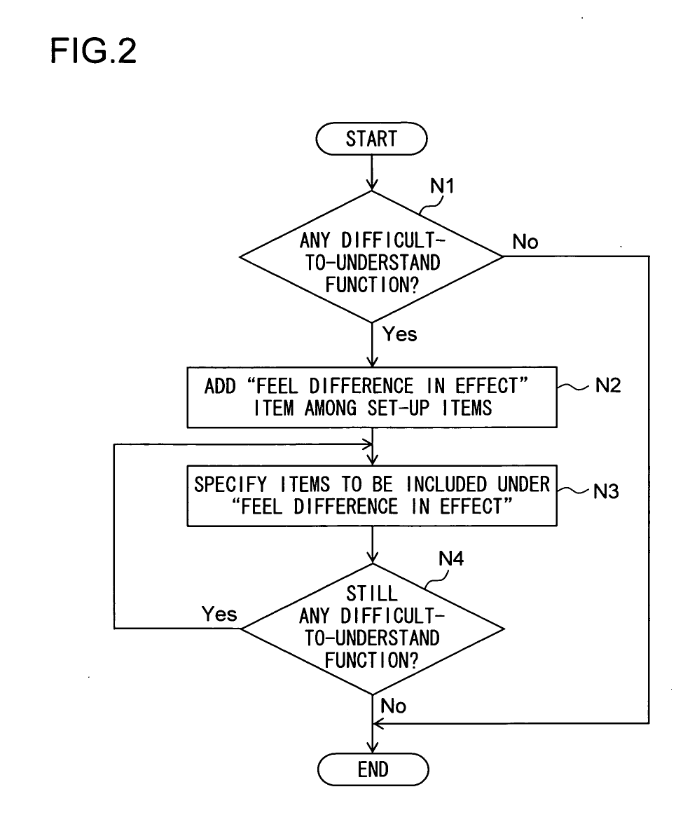

FIG. 2 is a flow chart of the procedure for including a “feel difference in effect” item among step-up items in designing stages. Now, with reference to this flow chart, a description will be given of the procedure for including a “feel difference in effect” item among step-up items in designing stages.

If there is a function difficult for the user to understand (step N1), an item named “feel difference in effect” is added among set-up items (step N2). Then what specific items to include under the “feel difference in effect” item are specified (step N3). Specifically, specificied here as specific items to be included under the “feel difference in effect” item are: a black level switching function, a noise reduction suppressing function, and a virtual surround effect generating function. Thereafter if there is still any other function difficult for the user to understand (step N4), it is added among the specific items to be included under the “feel difference in effect” (step N3).

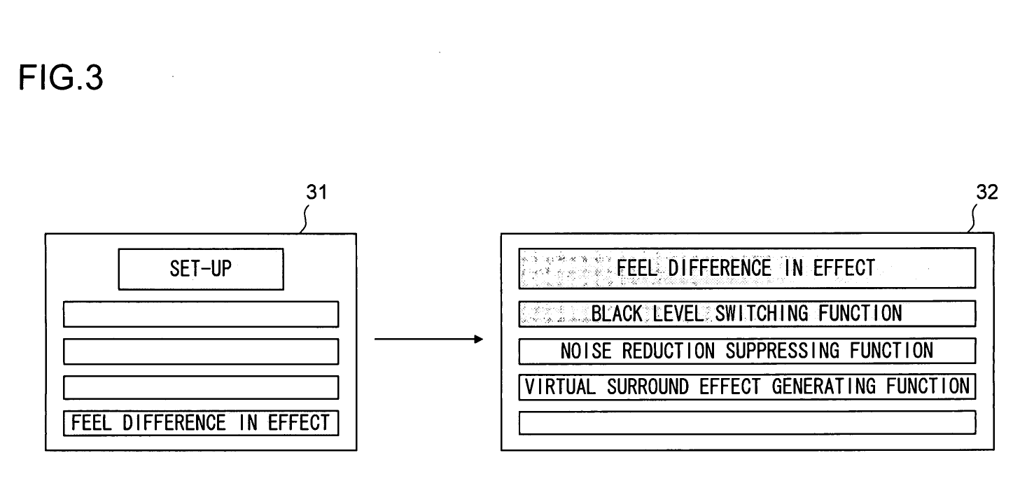

FIG. 3 is a diagram showing examples of the set-up screen in the embodiment under discussion. In FIG. 3, reference numeral 31 represents an example of the set-up screen displayed on the display apparatus 20. In this set-up screen 31, a “feel difference in effect” item is added among set-up items. Reference numeral 32 represents a screen showing the items included under the “feel difference in effect” item. Specifically, this screen 32 shows items concerning a “black level switching function”, a “black level switching function”, and a “virtual surround effect generating function”.

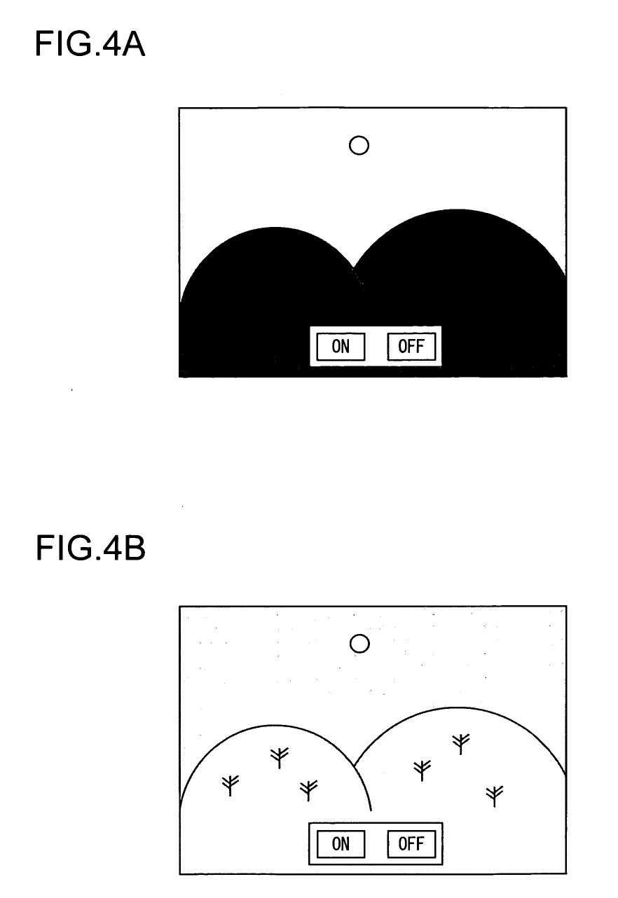

FIGS. 4A and 4B are diagrams showing examples of video for clarifying the difference produced in video by the black level switching function when it is on in comparison with when it is off. FIG. 4A shows an example of video with the black level switching function off, and FIG. 4B shows an example of video with the black level switching function on.

When the black level switching function is off, the system controller 22 reads from the flash ROM 23 a black-level-adjustment video signal for use when the black level switching function is off, to display video as shown in FIG. 4A on the display apparatus 20. When the black level switching function is on, the system controller 22 reads from the flash ROM 23 a black-level-adjustment video signal for use when the black level switching function is on, to display video as shown in FIG. 4B on the display apparatus 20.

A comparison between the video shown in FIG. 4A and that shown in FIG. 4B shows that details that are difficult to discern in the low-key video shown in FIG. 4A are easy to discern in the video shown in FIG. 4B. This lets the user feel the effect of the black level switching function.

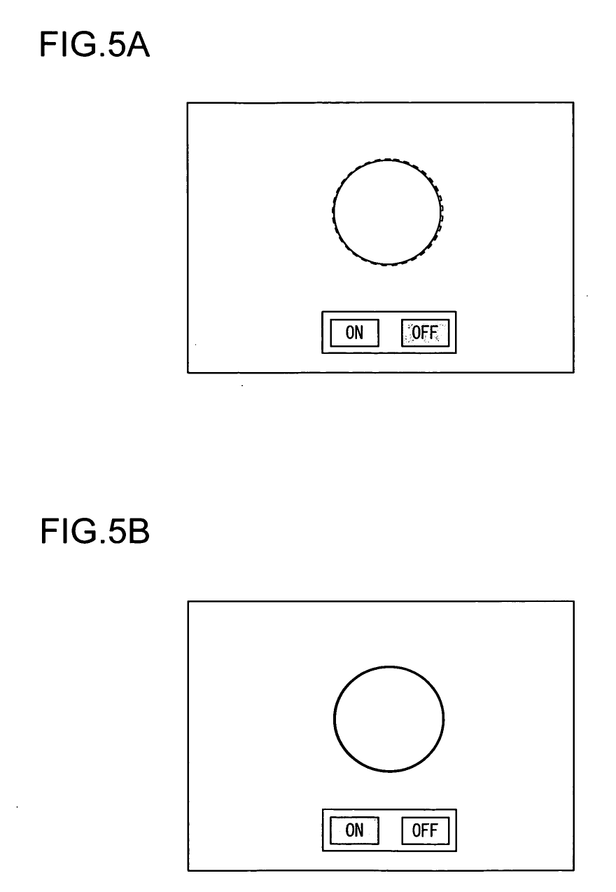

FIGS. 5A and 5B are diagrams showing examples of video for clarifying the difference produced in video by the noise reduction suppressing function when it is on in comparison with when it is off. FIG. 5A shows an example of video with the noise reduction suppressing function off, and FIG. 5B shows an example of video with the noise reduction suppressing function on.

When the noise reduction suppressing function is off, the system controller 22 reads from the flash ROM 23 a noise-reduced video signal to display video as shown in FIG. 5A on the display apparatus 20. When the noise reduction suppressing function is on, the system controller 22 reads from the flash ROM 23 a non-noise-reduced video signal to display video as shown in FIG. 5B on the display apparatus 20.

A comparison between the video shown in FIG. 5A and that shown in FIG. 5B shows that details that flicker in the video shown in FIG. 5A disappear in the video shown in FIG. 5B. This lets the user feel the effect of the noise reduction suppressing function.

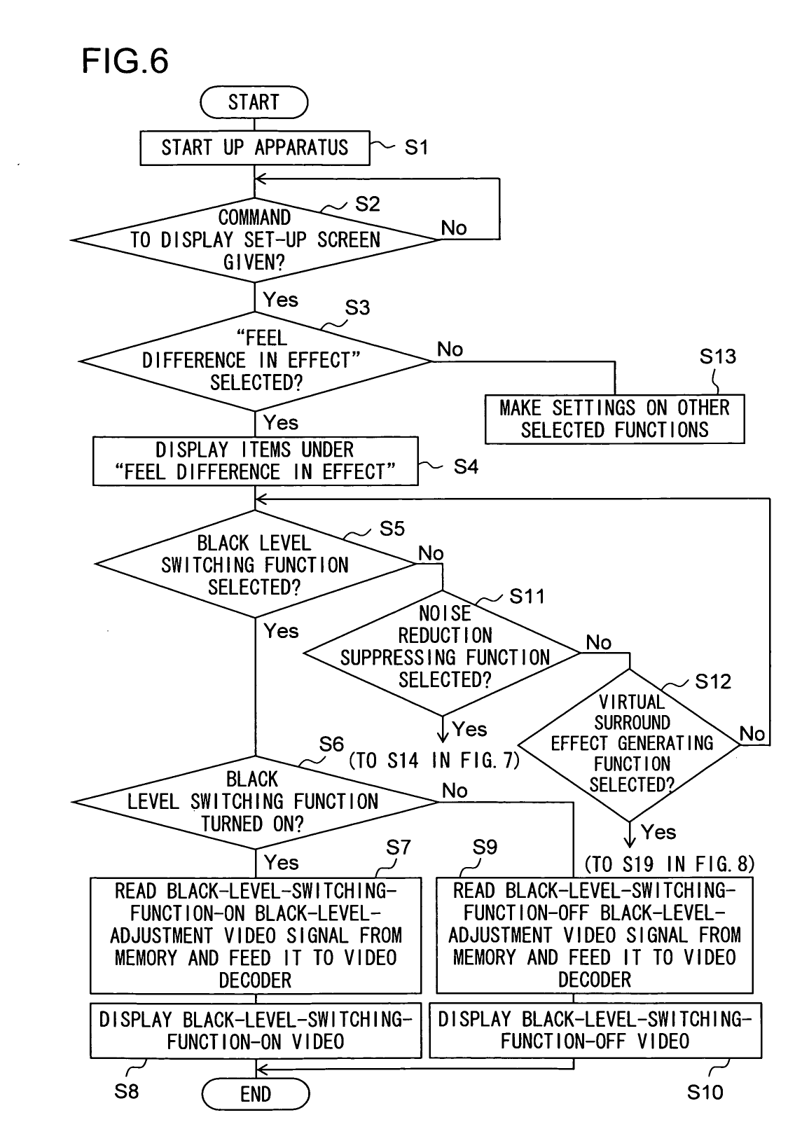

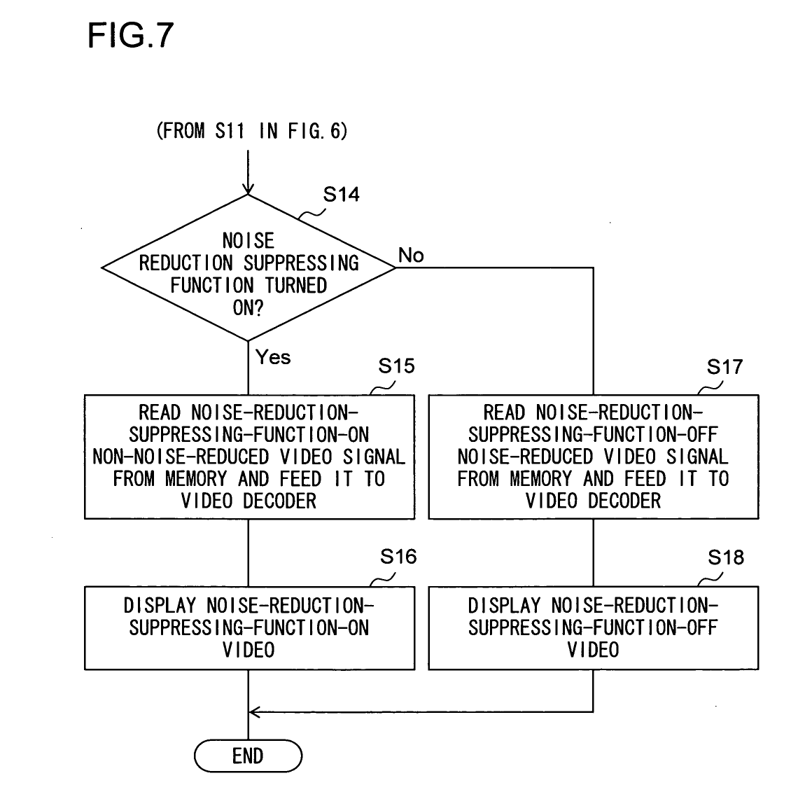

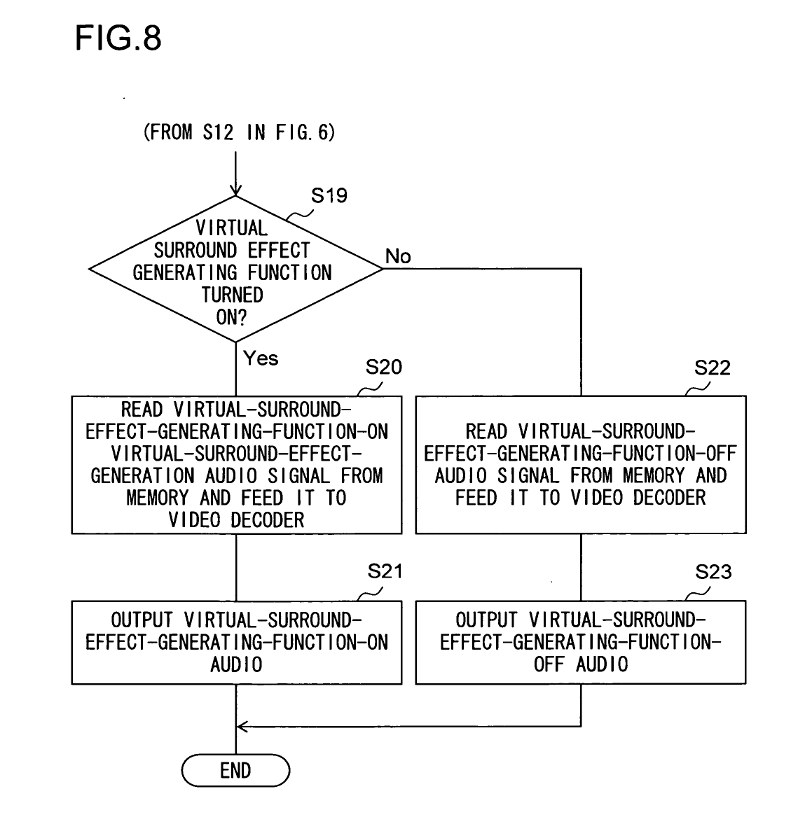

FIGS. 6 to 8 are flow charts showing the procedure for letting the user feel the differences effected by functions for which settings can be made in a set-up operation in the embodiment under discussion. Now, with reference to these flow charts, a description will be given of the procedure for letting the user feel the differences effected by functions for which settings can be made in a set-up operation.

First, the power to the DVD recorder is turned on to start it up (step S1). Thereafter, when the remote control 21 is so operated as to give a command to display the set-up screen (step S2), in response, the system controller 22 displays the set-up screen on the display apparatus 20. Then, when the remote control 21 is so operated as to select the “feel difference in effect” item in the set-up screen (for example, as in the set-up screen 31 shown in FIG. 3) (step S3), the system controller 22 shows the items (for example, as in the screen 32 shown in FIG. 3) included under the “feel difference in effect” item (step S4).

When, among the items included under the “feel difference in effect” item, the “black level switching function” is selected (step S5) and then the black level switching function is turned on (step S6), the black level switcher 224 of the system controller 22 reads from the memory (flash ROM 23) a black-level-adjustment video signal for use when the black level switching function is on, and feeds it to the video decoder 15 (step S7). The black-level-adjustment video signal decoded by the video decoder 15 is then fed, via the video processor 17 and the video encoder 18, to the display apparatus 20. Thus, the display apparatus 20 displays video to be displayed when the black level switching function is on (for example, as shown in FIG. 4B) (step S8).

When the black level switching function is turned off (step S6), the black level switcher 224 of the system controller 22 reads from the memory (flash ROM 23) a black-level-adjustment video signal for use when the black level switching function is off, and feeds it to the video decoder 15 (step S9). The black-level-adjustment video signal decoded by the video decoder 15 is then fed, via the video processor 17 and the video encoder 18, to the display apparatus 20. Thus, the display apparatus 20 displays video to be displayed when the black level switching function is off (for example, as shown in FIG. 4A) (step S10).

In this way, with respect to the black level switching function, for example, a comparison between the video shown in FIG. 4A and that shown in FIG. 4B shows that details that are difficult to discern in the low-key video shown in FIG. 4A are easy to discern in the video shown in FIG. 4B. Thus, the user can feel the effect of the black level switching function.

Next, when, among the items included under the “feel difference in effect” item, the “noise reduction suppressing function” is selected (step S11) and then the noise reduction suppressing function is turned on (step S14), the noise reduction suppressor 225 of the system controller 22 reads from the memory (flash ROM 23) a non-noise-reduced video signal for use when the noise reduction suppressing function is on, and feeds it to the video decoder 15 (step S15). The non-noise-reduced video signal decoded by the video decoder 15 is then fed, via the video processor 17 and the video encoder 18, to the display apparatus 20. Thus, the display apparatus 20 displays video to be displayed when the noise reduction suppressing function is on (for example, as shown in FIG. 5B) (step S16).

When the noise reduction suppressing function is turned off (step S14), the noise reduction suppressor 225 of the system controller 22 reads from the memory (flash ROM 23) a noise-reduced video signal for use when the noise reduction suppressing function is off, and feeds it to the video decoder 15 (step S17). The noise-reduced video signal decoded by the video decoder 15 is then fed, via the video processor 17 and the video encoder 18, to the display apparatus 20. Thus, the display apparatus 20 displays video to be displayed when the noise reduction suppressing function is off (for example, as shown in FIG. 5A) (step S18).

In this way, with respect to the noise reduction suppressing function, for example, a comparison between the video shown in FIG. 5A and that shown in FIG. 5B shows that details that flicker in the video shown in FIG. 5A disappear in the video shown in FIG. 5B. Thus, the user can feel the effect of the noise reduction suppressing function.

Next, when, among the items included under the “feel difference in effect” item, the “virtual surround effect generating function” is selected (step S12) and then the virtual surround effect generating function is turned on (step S19), the audio switcher 226 of the system controller 22 reads from the memory (flash ROM 23) a virtual-surround-effect-generation audio signal for use when the virtual surround effect generating function is on, and feeds it to the audio decoder 11 (step 20). The virtual-surround-effect-generation audio signal decoded by the audio decoder 11 is then converted into an analog audio signal by the D/A converter 16, and is fed, via an unillustrated audio amplification circuit, to the speaker 19, which then outputs audio to be outputted when the virtual surround effect generating function is on (step S21). Here, it is assumed that there are provided a plurality of the speaker 19.

When the virtual surround effect generating function is turned off (step SI 9), the audio switcher 226 of the system controller 22 reads from the memory (flash ROM 23) a audio signal for use when the virtual surround effect generating function is off, and feeds it to the audio decoder 11 (step 22). The audio signal decoded by the audio decoder 11 is then converted into an analog audio signal by the D/A converter 16, and is then fed, via the unillustrated audio amplification circuit, to the speaker 19, which then outputs audio to be outputted when the virtual surround effect generating function is off (step S23).

In this way, with respect to the virtual surround effect generating function, the user can feel virtual-surround-effect-generation audio that is outputted when the function is on and virtual-surround-effect-generation audio that is outputted when the function is off.

As described above, according to the present invention, with respect to functions whose effects are difficult to guess from a user's manual, specific examples are presented in the course of a set-up operation so that the user can, by actually looking at and listening to their effects, feel the differences produced by those functions when enabled in comparison with when disabled. The user can thereby fully realize in what situations (in video and audio) to use those functions and thus effectively use them.

The embodiment specifically described above deals with a case where a black level switching function and a noise reduction suppressing function are taken up as examples of items concerning video adjusting functions and a virtual surround effect generating function as an example of an item concerning a sound effect generating function. It should be understood, however, that any number of other functions may be added among the items included under the “feel difference in effect” item so long as their effects are difficult for the user to guess.

What is claimed is:

1. An optical disc apparatus that permits playback of information recorded on an optical disc or that permits recording and playback of information to and from an optical disc,
wherein
set-up items include an item named “feel difference in effect” which includes at least an item concerning a video adjusting function and an item concerning a sound effect generating function, and
a system controller is provided that operates such that
when the video adjusting function is selected, a video-adjustment video signal previously stored in a memory is fed to a video output circuit to display video such that an exaggerated difference is effected by the video adjusting function and
when the sound effect generating function is selected, a sound-effect-generation audio signal previously stored in the memory is fed to an audio output circuit to output audio such that an exaggerated difference is effected by the sound effect generating function.

2. The optical disc apparatus of claim 1, wherein
the video adjusting function is at least a black level switching function for switching a black level of a video signal and a noise reduction suppressing function for suppressing noise reduction in video.

3. The optical disc apparatus of claim 1, wherein
the sound effect generating function is at least a function for generating a virtual surround effect.

4. The optical disc apparatus of claim 1, wherein
the system controller comprises:
a black level adjustor that adjusts, with respect to a video output circuit that outputs a video signal obtained by performing predetermined processing on a playback signal played back from the optical disc, at least a black level of the video signal;
a picture quality adjuster that adjusts sharpness of video to suppress noise reduction in the video;
a sound effect generator that generates, with respect to an audio output circuit that outputs an audio signal obtained by performing predetermined processing on a playback signal played back from the optical disc, at least a sound effect such as a virtual surround effect;
a black level switcher that, when a black level switching function is selected, feeds a black-level-adjustment video signal previously stored in the memory to the video output circuit and drives the black level adjustor to switch the black level such that an exaggerated difference is effected by the black level switching function;
a noise reduction suppresser that, when a noise reduction suppressing function is selected, feeds a noise-reduction-suppression video signal previously stored in the memory to the video output circuit and drives the picture quality adjuster to adjust picture quality such that an exaggerated difference is effected by the noise reduction suppressing function; and
an audio switcher that, when the sound effect generating function is selected, feeds a sound-effect-generation audio signal previously stored in the memory to the audio output circuit and drives the sound effect generator to switch audio such that an exaggerated difference is effected by the sound effect generating function.

5. An optical disc apparatus that permits playback of information recorded on an optical disc or that permits recording and playback of information to and from an optical disc,
wherein
a system controller comprises:
a black level adjustor that adjusts, with respect to a video output circuit that outputs a video signal obtained by performing predetermined processing on a playback signal played back from the optical disc, at least a black level of the video signal;
a picture quality adjuster that adjusts sharpness of video to suppress noise reduction in the video; and
a sound effect generator that generates, with respect to an audio output circuit that outputs an audio signal obtained by performing predetermined processing on a playback signal played back from the optical disc, at least a virtual surround effect, set-up items include an item named “feel difference in effect” which includes at least an item concerning a black level switching function, an item concerning a noise reduction suppressing function, and an item concerning a sound effect generating function, and
the system controller further comprises:
a black level switcher that, when the black level switching function is selected, feeds a black-level-adjustment video signal previously stored in a memory to the video output circuit and drives the black level adjustor to switch the black level such that an exaggerated difference is effected by the black level switching function;
a noise reduction suppresser that, when the noise reduction suppressing function is selected, feeds a noise-reduction-suppression video signal previously stored in the memory to the video output circuit and drives the picture quality adjuster to adjust picture quality such that an exaggerated difference is effected by the noise reduction suppressing function; and
an audio switcher that, when a sound effect generating function is selected, feeds a sound-effect-generation audio signal previously stored in the memory to the audio output circuit and drives the sound effect generator to switch audio such that an exaggerated difference is effected by the sound effect generating function.
